(19) United States
(12) Patent Application Publication
(10) Pub. No.: US 2012/0074105 A1
(43) Pub. Date: Mar. 29, 2012

(54) LASER MACHINING METHOD AND APPARATUS

(75) Inventors: Tatsuki Okamoto, Tokyo (JP); Shinsuke Yura, Tokyo (JP); Tomotaka Katsura, Tokyo (JP); Daiji Morita, Tokyo (JP)

(73) Assignee: Mitsubishi Electric Corporation, Tokyo (JP)

(21) Appl. No.: 13/375,242

(22) PCT Filed: Jul. 10, 2009
(86) PCT No.: PCT/JP2009/003226

§ 371 Date: Nov. 30, 2011

(51) Int. Cl. B23K 26/04; B23K 26/38

(52) U.S. Cl. 219/121.62; 219/121.72

(57) ABSTRACT

A laser machining method and apparatus that allow accurate and fine scribing without the need of a large-scale dust collector and a large quantity of cleaning fluid when a thin film on a substrate is scribed by a laser beam. A laser beam from a laser beam source is focused by a lens, introduced into a window of piping and propagated through cleaning fluid, and the thin film is illuminated with the laser beam from the nozzle. Concurrently with this beam illumination, a jet of the cleaning fluid supplied using a fluid flow controller is discharged from the nozzle that is disposed about substantially the optical axis of the focused laser beam and sized in inside diameter such that the focused laser beam does not make a contact with the nozzle. By these processes, laser-scribing is performed.

### TECHNICAL FIELD

The present invention relates to a method and an apparatus for laser machining that machines, using a laser beam, a thin film on a substrate for a flat panel apparatus, such as a thin film solar cell, a liquid crystal device, an organic electroluminescence device, and a plasma display device.

### BACKGROUND ART

A leaser beam is generally used for separating a thin film on a substrate (hereinafter called scribing). In conventional scribing using the laser beam (laser scribing), a laser beam adapted for a light absorption wavelength of the thin film is used to heat the thin film or heat a partial component contained in the film, and by making use of its vaporization, a laser-beam illuminated portion of the thin film is removed (refer to Patent Document 1, for instance).

Since a thin film removed at this time is sticked, as dusts, on the substrate, cleaning is essential after laser scribing. For this reason, attempt is made to conduct laser beam illumination and cleaning simultaneously (refer to Patent Document 2, for instance).

When the substrate is large in size, a plurality of scribe lines needs to be made multiple times for a single substrate, and in scribing at a multi-layer thin film, a monitoring method is disclosed for improving an accuracy of the position of a scribe line between the thin films (refer to Patent Document 3, for instance).

In contrast, there is disclosed a laser machining method that uses a water column (water jet) as an optical waveguide, to direct both a laser beam and jet water onto the same machining region (refer to Non-Patent Document 1, for instance).

### PRIOR ART DOCUMENT

### Patent Document

### [Patent Document 1]

Japanese Unexamined Patent Application Publication No. H01-140677 (page 2, lower left-hand column, line 12 through lower right-hand column, line 20)

### [Patent Document 2]

Japanese Unexamined Patent Application Publication No. 2006-315030 (paragraphs 0018 through 0020, and FIG. 1)

### [Patent Document 3]

Japanese Unexamined Patent Application Publication No. 2008-71874 (paragraphs 0040 through 0046, and FIG. 1)

### [Non-Patent Document 1]

Laser-doped Silicon Solar Cells by Laser Chemical Processing (LCP) exceeding 20% Efficiency, 33rd IEEE Photovoltaic Specialist Conference, 12-16 May. 2008, St. Diego, Calif.

### DISCLOSURE OF INVENTION

### Problem that the Invention is to Solve

In the conventional laser machining methods described above, however, a large amount of dusts is generated by scribing. For this reason, there is a method such that a substrate is illuminated with a laser beam from a position opposite a thin film layer of the substrate, to remove the dusts generated on the surface of the thin film layer using a large-capacity duct collector, or a method such that scribing is performed within a cleaning tub.

However, a problem with those methods is that since a laser beam is reflected by the substrate surface to cause a loss, a substrate that passes the laser beam therethrough needs to be properly selected. Another problem is that the method of removing the dusts with the large-capacity dust collector makes the size of an apparatus larger to thereby generate noises and increase costs.

Further, a problem with the method of scribing in the cleaning tub is that a larger substrate leads to a large amount of cleaning fluid to be consumed, thus increasing environmental load.

With respect to positional control of the scribe line, there is a method of illuminating a substrate with a laser beam to detect a position from a speckle pattern; however, a problem with the method is that the position cannot be accurately detected when there are foreign objects, such as dusts and/or water droplets, present on the substrate.

In addition, a problem with the method of using a water column (water jet) as a laser beam guide is that since the laser beam expands to the entire cross-section of the water column, a minimum surface area of a machining region cannot be made smaller than the minimum cross-sectional area of the water column.

The present invention is directed to overcome the above problems, and an object of the invention is to provide a laser machining method and apparatus that accurately perform fine scribing without the need of a large dust collector and a large amount of cleaning fluid when scribing a thin film on a substrate using a laser beam.

### Means for solving the Problem

A laser machining method according to the present invention is characterized in that a thin film on a substrate is machined by discharging, concurrently with the laser beam illumination, a columnar jet of cleaning fluid whose diameter is greater than that of a laser beam, on the substantially same axis as the optical axis of the laser beam.

A laser machining apparatus according to the present invention comprises a laser beam source that emits a laser beam; a lens that focuses the laser beam; a fluid flow controller that supplies cleaning fluid and controls a flow speed of the cleaning fluid; piping provided with a window for introducing the focused laser beam, which introduces the cleaning fluid; and a nozzle disposed opposite the window for the piping and about substantially the optical axis of the laser beam introduced from the window into the cleaning fluid, and sized so that the laser beam does not make a contact with an inner wall of the nozzle, the nozzle discharging a jet of the cleaning fluid concurrently with illumination of a workpiece by the laser beam propagating in the cleaning fluid.

### Advantageous Effects of the Invention

In the present invention, laser scribing is performed by discharging a jet of cleaning fluid at a machining region concurrently with the laser beam illumination, and dusts generated during ablation are made to be caught in the cleaning fluid. Thus, the dusts are not scattered, and the dusts are prevented from sticking to the surroundings of the machining region and to optical components of the laser machining apparatus, so that the laser machining is achieved without the need of a dust collector and a large amount of the cleaning fluid.

Further, by detecting a position of a machining point while a jet of the cleaning fluid is being discharged at the machining region, the position can be detected accurately even on a substrate to which foreign objects such as dusts and/or water droplets stick, while the foreign objects are being removed from the substrate.

In addition, the focused laser beam is located at a position and sized in diameter such that the laser beam does not make a contact with the inner wall of the nozzle and then the beam passes through the cleaning fluid, whereby fine machining can be made to the focusing limit of the laser beam.

### BRIEF DESCRIPTION OF DRAWINGS

FIG. 1 is a schematic diagram illustrating a configuration of a laser machining apparatus according to Embodiment 1 of the present invention;

FIG. 2 is a cross-sectional view illustrating a configuration of a working head of the laser machining apparatus according to Embodiment 1 of the present invention;

FIG. 3 is a cross-sectional diagram illustrating another configuration of the working head of the laser machining apparatus according to Embodiment 1 of the present invention;

FIG. 4 is a set of enlarged cross-sectional diagrams illustrating fabrication processes of a thin film solar cell plate fabricated by the laser machining method using the laser machining apparatus according to Embodiment 1 of the present invention;

FIG. 5 is a top plan view illustrating an entire configuration of the thin film solar cell plate processed by the laser machining method using the laser machining apparatus according to Embodiment 1 of the present invention;

FIG. 6 is a cross-sectional view illustrating a configuration of a working head of a laser machining apparatus according to Embodiment 2 of the present invention;

FIG. 7 is a cross-sectional view illustrating a configuration of a working head of a laser machining apparatus according to Embodiment 1 of the present invention;

FIG. 8 is a cross-sectional view illustrating a configuration of a working head of a laser machining apparatus according to Embodiment 4 of the present invention;

FIG. 9 is a cross-sectional view illustrating a configuration of a working head of a laser machining apparatus according to Embodiment 5 of the present invention;

FIG. 10 is a cross-sectional view illustrating a configuration of a working head of a laser machining apparatus according to Embodiment 6 of the present invention;

FIG. 11 is a cross-sectional view illustrating a configuration of a working head of a laser machining apparatus according to Embodiment 7 of the present invention;

FIG. 12 is a set of views illustrating observation timing at a time of the laser machining using the laser machining apparatus according to Embodiment 7 of the present invention; and

FIG. 13 is a cross-sectional view illustrating a configuration of a working head of a laser machining apparatus according to Embodiment 8 of the present invention.

### BEST MODE FOR CARRYING OUT THE INVENTIONS

### Embodiment 1

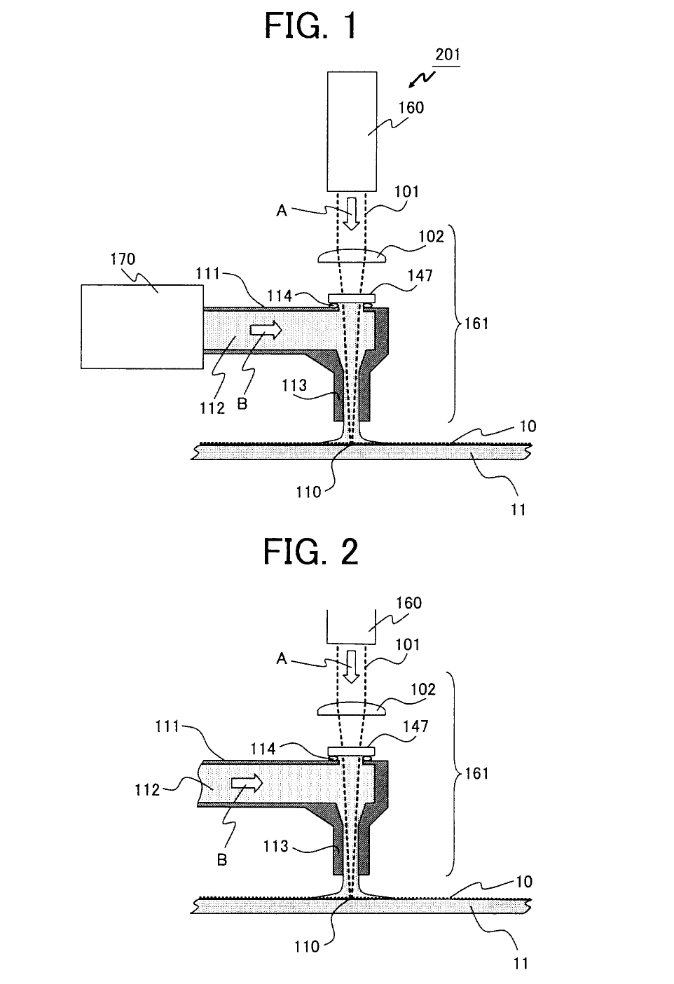

Embodiment 1 will be described with reference to figures. FIG. 1 is a schematic diagram illustrating an entire configuration of a laser machining apparatus 201, using a laser machining method, according to Embodiment 1 of the present invention. FIG. 2 is a cross-sectional view illustrating a configuration of a working head 161 at a time of laser beam illumination in the laser machining apparatus 201 according to Embodiment 1 of the present invention.

Referring to FIG. 1, the laser machining apparatus 201 comprises a laser beam source 160 that emits a laser beam 101, a fluid flow controller 170 that supplies cleaning fluid 112 onto an insulative substrate 11 and controls a flow speed of the fluid, and a working head 161 that focuses the laser beam 101 from the laser beam source 160, and illuminates a thin film 10 on the insulative substrate 11 with the focused laser beam 101, concurrently with a jet of the cleaning fluid 112 being directed from the fluid flow controller 170.

As shown in FIG. 2, the working head 161 comprises, as basic constituent elements, a lens 102 that focuses the laser beam 101 from the laser beam source 160, piping 111 for introducing, in a direction of illumination of the laser beam 101, a water flow of the cleaning fluid 112 that is to be supplied with the speed of the water flow controlled using the flow fluid controller 170, and a nozzle 113 that directs the focused laser beam 101 onto the machining region on the substrate, concurrently with the flow of water serving as the cleaning fluid 112.

The nozzle 113 is disposed, about substantially the optical axis of the focused laser beam 101, at a position and sized in diameter such that the focused laser beam does not make a contact with the inner wall of the nozzle 113. Provided to the piping 111 is an entrance window 147 that introduces the focused laser beam 101 into the cleaning fluid 112 and guides it in the direction of the nozzle 113. The entrance window 147 is sealed between itself and the piping 111 enclosing the cleaning fluid 112, with a packing ring 114.

Through this configuration, the nozzle 113 discharge, concurrently with the laser beam 101 illumination, a columnar jet of the cleaning fluid 112 whose diameter is greater than that of a laser beam 101, on the substantially same axis as the optical axis of the laser beam.

Next, operation of the laser machining apparatus 201 according to Embodiment 1 will be described. Referring to FIG. 2, the laser beam 101 to be used for machining is traveling in a direction A from the laser beam source 160.

The laser beam 101, while being focused or image-focused by a lens 102 toward a working point 110 of the thin film 10 on the insulative substrate 11, enters through the entrance window 147 into the cleaning fluid 112 such as pure water guided by means of the piping 111.

The laser beam 101 propagates in the cleaning fluid 112 while being focused and image-focused, and the thin film 10 formed on the insulative substrate 11 is illuminated with the beam in a desirable shape, concurrently with the jet of the cleaning fluid 112 being discharged from the nozzle 113. A portion of the thin film 10, illuminated with the laser beam 101, absorbs the laser beam 101, and is ablated owing to heat generation and then removed from the insulative substrate 11.

In contrast, the cleaning fluid 112 used for cleaning is being supplied in a direction B through the piping 111 from the fluid flow controller 170, as shown in FIG. 2. The cleaning fluid 112 changes its direction of flow in the direction A at the end portion of the piping 111 and is guided into the nozzle 113 by which its flow is rectified, and then discharged toward the thin film 10 formed on the insulative substrate 11.

The discharged jet of the cleaning fluid 112 catches dusts generated from ablation of the thin film 10 on the insulative substrate 11 as a result of illumination of the laser beam 101, and removes them from the substrate 11. The dust-containing cleaning fluid 112 is recovered using a recovery unit, not shown.

By moving the working head 161 relatively with respect to the insulative substrate 11, the illumination of the laser beam 101 is made linear, and thereby developing linear ablation on the thin film 10, the insulative substrate 11 is scribed while the dusts is being removed,

In this way, the laser scribing is performed by discharging the jet of the cleaning fluid 112 at the working point 110 concurrently with illumination of the working point by the laser beam 101, and the dusts generated from ablation is caught in the fluid 112. Thus, the dusts are not scattered and prevented from sticking to the surroundings of the machining region and to optical components of the laser machining apparatus, so that the machining is achieved without the need of a dust collector and a large amount of the cleaning fluid

Further, by directing the jet of the cleaning fluid 112 on the working point 110, a portion which otherwise has not been ablated completely from the substrate during scribing can be removed, and cleaning process after scribing can be thereby cancelled or simplified. Moreover, cooling of the working point 110 can be expedited, thereby preventing crystallization of the thin film 10 in the surroundings of the working point 110—which is a cause of a transmission path for leak current in the case of series interconnection.

In addition, the nozzle 113 is located at a position and sized in diameter such that the focused laser beam 101 does not make a contact with the inner wall of the nozzle 113, so that fine machining can be made to the focusing limit of the laser beam.

Furthermore, since the laser beam 101 passes through the cleaning fluid 112 of a refractive index higher than that of gas, the beam 101 can be focused to a small spot and reflective loss on the surface of the thin film 10 can be reduced when compared to direct illumination, from the air, of the thin film 10 by the laser beam 101. Thus, the width of scribing can be reduced and efficient scribing can be made.

The laser beam 101 is selected according to light absorption properties of the thin film 10 to be scribed. Used for a thin film solar cell are, for instance, a fundamental (whose wavelength is about 1 μm), a second harmonic (whose wavelength is about 0.5 μm), and a third harmonic (whose wavelength is about 0.3 to 0.4 μm), of solid laser or fiber laser such as YAG.

The laser beam 101 used may also be of a microsecond, nanosecond or picosecond pulsed laser, or a continuous wave laser, according to ablation properties of the thin film 10 to be scribed.

In the above description, an example is shown where pure water is employed for the cleaning fluid; however, liquid may be used which causes or expedites a chemical reaction of the thin film 10 to be scribed, by the illumination of the laser beam 101. For instance, an alkaline solution such as KOH solution or an acidic solution such as HNO3 may be employed.

In the above description, an example is also shown where a glass plate is employed for the insulative substrate 11; however, a flexible resin film may be used.

The thin film 10 to be scribed can be partially ablated not only by a method of directly ablating by means of the laser beam 101, but also by a method of absorbing the laser beam 101 into a thin film layer underlying the thin film 10 and ablating the thin film 10 concurrently with the ablation of the thin film layer, or by a method of ablating the thin film 10 using heat conducted from the thin film layer.

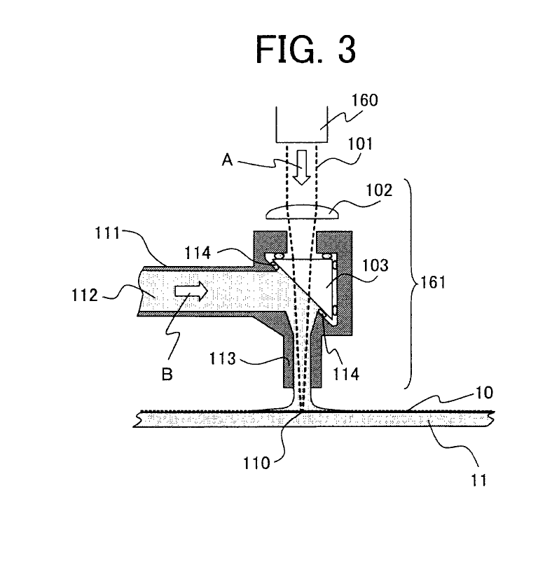

In addition, a prism 103 may be provided, as shown in FIG. 3, in place of the entrance window 147. In this case, not only can the focused laser beam 101 be introduced into the cleaning fluid 112 in substantially the same direction as the entry direction, but also the entrance window can be prevented from browning owing to the cleaning fluid 112 being stagnant at a position through which the laser beam 101 enters. Pressure loss occurring when the direction of the flow of the cleaning fluid 112 changes to that of the flow from the nozzle 113 can also be reduced.

When the prism 103 is employed, a refraction angle of the laser beam 101 on a surface of the prism 103 through which the laser beam 101 passes can be made smaller by making smaller the difference between refractive indices of the prism 103 and the cleaning fluid 112. Reflective loss occurring between the prism 103 and the cleaning fluid 112 can also be reduced.

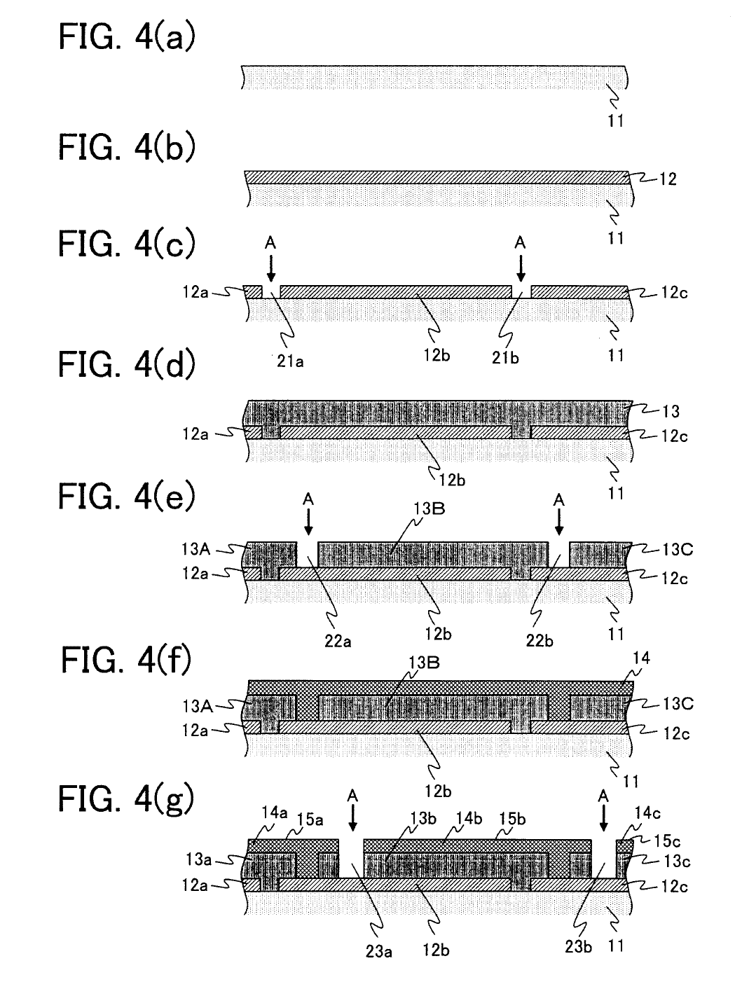

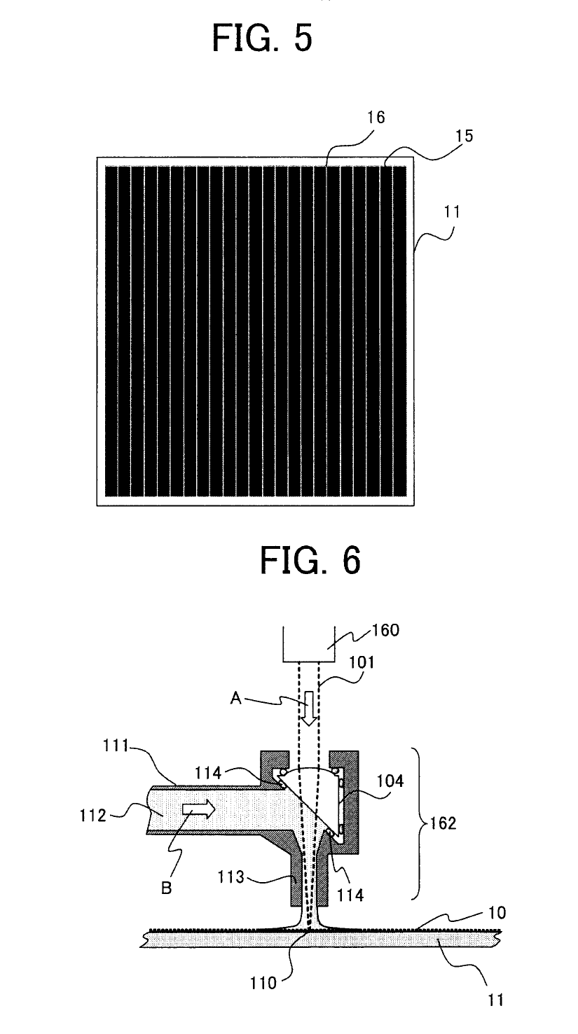

Next, a thin film solar cell will be described as an example of a semiconductor device machined using laser machining apparatus 201 by the laser machining method in Embodiment 1. FIG. 4 is a set of enlarged cross-sectional diagrams illustrating fabrication processes of a thin film solar cell plate fabricated using the beam machining apparatus 201 of FIG. 1, and FIG. 5 is a top plan view illustrating an entire configuration thereof.

FIG. 4(g) is an enlarged cross-sectional diagram illustrating the thin film solar cell plate fabricated using the laser machining apparatus 201. Numeral 11 represents the insulative substrate; numeral 12 (12a, 12b, 12c . . . ), a transparent electrode; numeral 13 (13a, 13b, 13c . . . ), a power generation layer; numeral 14 (14a, 14b, 14c . . . ), a backside electrode; numeral 15 (15a, 15b, 15c . . . ), a photoelectric conversion region; numeral 21 (21a, 21b, 21c . . . ), a first scribed portion; numeral 22 (22a, 22b, 22c . . . ), a second scribed portion; and numeral 23 (23a, 23b, 23c . . . ), a third scribed portion. Suffixes a, b and c denote the classification of the power generation region.

As shown in FIG. 4(g), the transparent insulative substrate 11, made up of a glass plate with a thickness of one to three milli-meters, is provided, on which is formed the transparent electrode 12 (12a, 12b, 12c . . . ). Further formed, as the power generation layer 13 (13a, 13b, 13c . . . ), on the transparent electrode 12 (12a, 12b, 12c . . . ) is, for instance, an amorphous silicon semiconductor layer having a PN junction.

Further, formed on the power generation layer 13 (13a, 13b, 13c . . . ) is, for instance, the backside electrode 14 (14a, 14b, 14c . . . ) such as of aluminum or silver. This converts an optical energy entering from the insulative substrate 11 into an electrical energy.

In the thin film solar cell, for enhancement of efficiency in the power generation, the photoelectric conversion region 15 (15a, 15b, 15c . . . ) is interconnected in series after separating the photoelectric conversion region 15 (15a, 15b, 15c . . . ) of the insulative substrate 11. Laser-scribing is employed when this photoelectric conversion region is separated.

First, the transparent electrode 12 is uniformly formed (FIG. 4(b)) on the upper surface of the insulative substrate 11 (FIG. 4(a)). In the transparent electrode 12, the first scribed portions 21a, 21b . . . are formed in such a way that the laser machining apparatus 201 according to Embodiment 1 partially ablates the transparent electrode 12 in the form of a line, using a laser beam whose wavelength is absorbed into the transparent electrode 12, so that the region is divided at its portion(s) corresponding to the photoelectric conversion region 15 (15a, 15b, 15c . . . ) into the transparent electrodes 12a, 12b, 12c . . . (FIG. 4(c)).

Next, the power generation layer 13 is vapor deposited on the insulative substrate 11 that is formed with the regions 12a, 12b, 12c . . . of the transparent electrode 12 corresponding to the photoelectric conversion regions 15a, 15b, 15c . . . by a method such as plasma CVD (FIG. 4(d)); thereafter, the laser machining apparatus 201 partially ablates the power generation layer 13 in the form of a line, with the transparent electrode 12 being left, using a laser beam whose wavelength is absorbed into only the power generation layer 13. By the linear ablation, the second scribed portions 22a, 22b . . . are formed, and the region is divided into the regions 13A, 13B, 13C . . . corresponding to the photoelectric conversion region 15a, 15b, 15c . . . (FIG. 4(e)).

Subsequently, the backside electrode 14 is vapor deposited on the insulative substrate 11 that is formed with the regions 13A, 13B, 13C . . . of the power generation layer 13 corresponding to the photoelectric conversion regions 15a, 15b, 15c . . . (FIG. 4(f). Thereafter, in the backside electrode 14, the third scribed portions 23a, 23b . . . are formed by partially ablating in the form of a line the backside electrode 14 and regions 13A, 13B, 13C . . . of the power generation layer 13 using the laser machining apparatus 201, and the regions 13 and 14 are divided into the regions 13a, 13b, 13c . . . and the regions 14a, 14b, 14c . . . , respectively, corresponding to the photoelectric conversion regions 15a, 15b, 15c . . . (FIG. 4(g)).

Series interconnection of each of the photoelectric conversion regions 15a, 15b, 15c . . . is accomplished by dividing, with the transparent electrode 12 being left, the region into the regions 14a, 14b, 14c . . . of the backside electrode 14 corresponding to the photoelectric conversion region 15, and the regions 13a, 13b, 13c . . . of the power generation layer 13.

In the thin film solar cell plate, as shown in FIG. 5, a plurality of the photoelectric conversion regions 15, divided by a scribed line 16 including the first scribed portion 21, the second scribed portion 22, and the third scribed portion 23, is interconnected in series on the insulative substrate 11 of one meter square.

When the backside electrode 14 and the regions 13A, 13B, 13C . . . of the power generation layer 13 . . . are divided into the regions 14a, 14b, 14c . . . and the regions 13a, 13b, 13c . . . corresponding to the photoelectric conversion regions 15a, 15b, 15c . . . , the backside electrode 14 and the power generation layer 13 are partially ablated in the form of a line, using the laser beam whose wavelength is absorbed into both the backside electrode 14 and the power generation layer 13.

In place of using the laser beam whose wavelength is absorbed into the both, as described above, when the backside electrode 14 and partial portions of the regions 13A, 13B, 13C . . . of the power generation layer 13 are divided, a method of ablation may be used such that the laser beam is absorbed into the partial portions of the regions 13A, 13B, 13C . . . of the power generation layer 13 of the backside electrode 14, and then the backside electrode 14 is ablated with the ablation of the regions 13A, 13B, 13C . . . of the power generation layer 13. Another method of ablations may be used such that the backside electrode 14 is ablated by heat transmitted from the regions 13A, 13B, 13C . . . of the power generation layer 13. These methods expand the scope of selection of type of the backside electrode 14, the laser beam, or the like.

In any one of the above ablations, by performing scribing with the laser machining apparatus 201 while the jet of the cleaning fluid 112 is being discharged, dusts generated during ablation are caught in the cleaning fluid 112. Thus, the dusts are not scattered and prevented from sticking to the surroundings of the machining region and to optical components of the laser machining apparatus, so that machining is achieved without the need of a dust collector and a large amount of the cleaning fluid.

Further, when the above three layers are scribed, the region for scribing, i.e., the region from the first scribed portion 21 to the third scribed portion 23 cannot contribute to electric power generation, and for reduction of the scribe region, the width of scribe portion needs to be reduced, and fine machining can be made to the focusing limit of the laser beam using the laser machining apparatus 201, and an efficient cell plate can be formed.

As described above, in Embodiment 1, since laser scribing is performed by discharging the jet of the cleaning fluid 112 at the working point 110 concurrently with the illumination of the working point 101 by the laser beam 101 and the dusts generated during ablation are made to be caught in the cleaning fluid 112, the dusts are not scattered and are prevented from sticking to the surroundings of the machining region and to optical components of the laser machining apparatus, so that machining is achieved without the need of a dust collector and a large amount of the cleaning fluid.

In addition, by the discharge of the jet of the cleaning fluid, a portion that otherwise has not been ablated completely from the substrate during scribing can also be removed and the cleaning process after scribing can also be cancelled or simplified. Further, cooling of the machining region can be expedited, thereby preventing crystallization of the surrounding of the machining region, which is a cause of a transmission path for leak current in the case of series interconnection.

In addition, the nozzle 113 is located at a position and sized in diameter such that the focused laser beam 101 does not make a contact with the inner wall of the nozzle 113, so that fine machining can be made to the focusing limit of the laser beam.

Further, since the laser beam 101 is made to pass through the cleaning fluid 112 of a refractive index higher than that of gas, the laser beam can be focused to a small spot, when compared to the direct illumination, from the air, of a machining region by the laser beam, and reflective loss on the surface of the machining region can be reduced. In addition, the width of scribe portion can be reduced and efficient scribing can be made.

Moreover, when the thin film solar cell plate is formed, not only can the dusts be prevented from sticking thereto, but also scribing regions that do not contribute to electrical power generation can be made narrower, so that power generation layers that contribute to the power generation can be expanded, whereby efficiency in power generation can be achieved.

### Embodiment 2

FIG. 6 is a schematic diagram illustrating a configuration of a working head 162 at a time of laser beam illumination in a laser machining apparatus 202 according to Embodiment 2 of the present invention. Embodiment 2 includes a lens integral with a prism, 104, in place of the lens 102 and the prism 103 for the working head 161 according to Embodiment 1 as shown in FIG. 3.

The configurations of other elements and their operations are similar to those in Embodiment 1, and the corresponding elements are labeled with the same reference numerals as in FIG. 3 and their description will not be provided.

Since, in Embodiment 2, the lens 104 integral with the prism, is employed in which the lens focusing the laser beam 101 or focusing an image of the beam onto the working point 110 and the prism serving as the entrance window are integral with each other, it means that a short focal length lens can be used and thus the beam can be focused at a small area, thereby enabling fine machining.

Further, the weight of the working head can be reduced by reducing the size of the working head and the number of components of the optical system. When moving the working head, the lighter the weight of the working head, the faster it can be moved.

### Embodiment 3

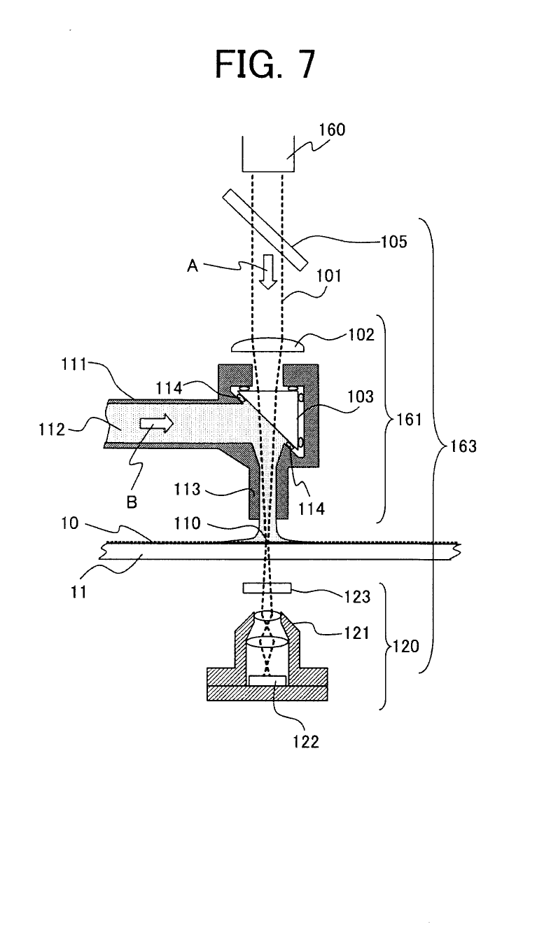

FIG. 7 is a schematic diagram illustrating a configuration of a working head 163 at a time of laser beam illumination in a laser machining apparatus 203 according to Embodiment 3 of the present invention. Embodiment 3 further includes a beam profile measuring device 120 in addition to the working head 161 according to Embodiment 1 shown in FIG. 3.

The configurations of other elements and their operation are similar to those in Embodiment 1, and the corresponding elements are labeled with the same reference numerals as in FIG. 3 and their description will not be provided.

As shown in FIG. 7, the beam profile measuring device 120 is configured with an object lens unit 121, a two-dimensional sensor 122 such as a CCD, and an optical filter 123 and disposed opposite the working head 161 with respect to the insulative substrate 11. An optical attenuator 105 is provided in the optical path of the laser beam 101, when necessary.

In Embodiment 3, the beam profile measuring device 120 is disposed opposite the working head 161 with respect to the insulative substrate 11. Thus, by adjusting the observation position of the object lens unit 121 to the laser-beam illuminated surface, an accurate illumination beam profile can be measured without the influence of the cleaning fluid.

Note that the beam profile measuring device 120 is not necessarily disposed below the insulative substrate 11. A beam profile may be measured by disposing a substrate equivalent to the insulative substrate 11 in another area and moving the working head 161 to a point directly above the beam profile measuring device 120 when measuring the beam profile.

### Embodiment 4

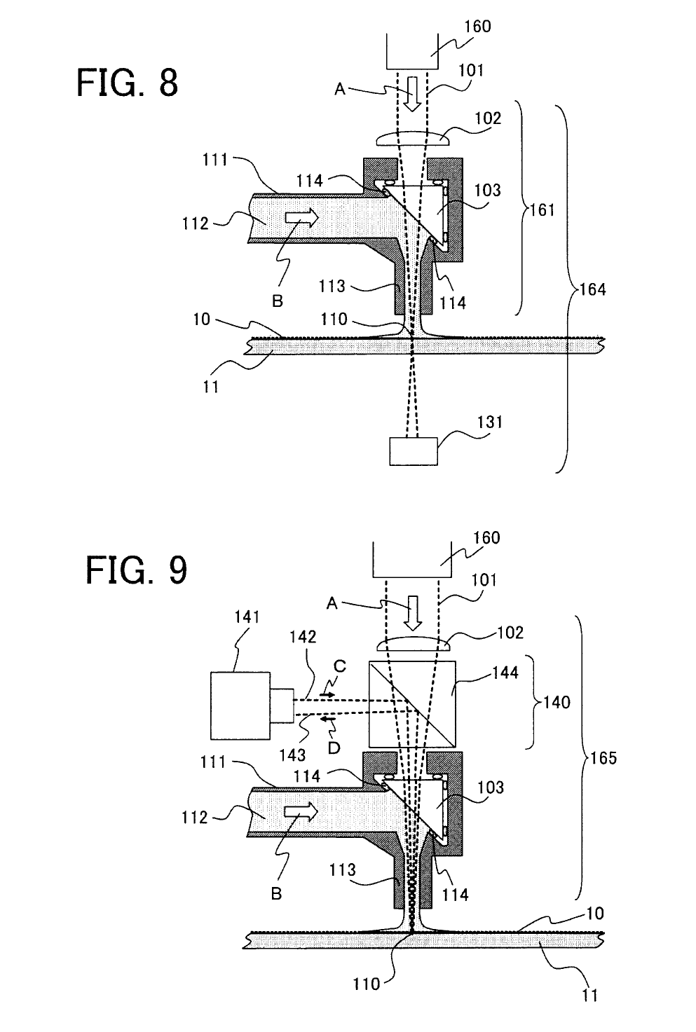

FIG. 8 is a schematic diagram illustrating a configuration of a working head 164 at a time of laser beam illumination in a laser machining apparatus 204 according to Embodiment 4 of the present invention. Embodiment 4 further includes a power meter 131 in addition to the working head 161 according to Embodiment 1, shown in FIG. 3.

The configurations of other elements and their operations are similar to those in Embodiment 1, and the corresponding elements are labeled with the same reference numerals as in FIG. 3 and their description will not be provided.

As shown in FIG. 8, the power meter 131 is disposed opposite the working head 161 with respect to the insulative substrate 11.

In Embodiment 4, since the power meter 131 is disposed opposite the working head 161 with respect to the insulative substrate 11, an accurate illumination beam power can be measured without the influence of the cleaning fluid.

### Embodiment 5

FIG. 9 is a schematic diagram illustrating a configuration of a working head 165 at a time of laser beam illumination in a laser machining apparatus 205 according to Embodiment 5 of the present invention. Embodiment 5 further includes a distance sensor unit 140 in addition to the working head 161 according to Embodiment 1, shown in FIG. 3.

The configurations of other elements and their operations are similar to those in Embodiment 1, and the corresponding elements are labeled with the same reference numerals as in FIG. 3 and their description will not be provided.

As shown in FIG. 9, the distance sensor unit 140 is constituted with a distance sensor 141 and a beam splitter 144.

Referring to FIG. 9, the distance sensor 141 emits a laser beam, to measure a distance by detecting a reflected beam from a measuring position. A distance-sensor beam 142, acting as a control beam, is the laser beam emitted from the distance sensor 141 in a direction C, and is reflected by the beam splitter 144, and propagates through a beam pencil of the laser beam 101 and the jet of the cleaning fluid 112 discharged from the nozzle 113, and then is directed toward the working point 110.

The distance-sensor beam 142 is reflected by the working point 110, and a distance-sensor beam 143, which is the reflected laser beam, is reflected by the beam splitter 144 in a direction D and returned to the distance sensor 141. The distance sensor 141 senses, as the control information, a distance between itself and the thin film 10 using the returned distance-sensor beam 143.

In Embodiment 5, by providing the distance sensor unit 140 to the working head 161, a measuring laser beam of the distance sensor 141 is made to pass through the same optical system as that of the machining laser beam 101. Thus, a variation in distance from the working head at a laser-beam illuminated position can be measured accurately.

Since the position of the working point is detected while a jet of the cleaning fluid 112 is being discharged from the nozzle 113, foreign objects such as dusts and/or water droplets can be removed even from a substrate on which the foreign objects stick, and the position of the substrate can be detected accurately.

In addition, by separating the beam region between the distance sensor beam and the laser beam 101, low-noise observations can be conducted.

Note that by using a different wavelength between the laser beam 101 and the beam for the distance sensor 141, the distance can be uniformly measured using a wavelength filter.

Although shown here is an example where the distance sensor 141 using the laser beam is employed, any different type of sensor may be used as long as the distance can be measured using propagation of the beam within the beam pencil of the machining laser beam 101.

### Embodiment 6

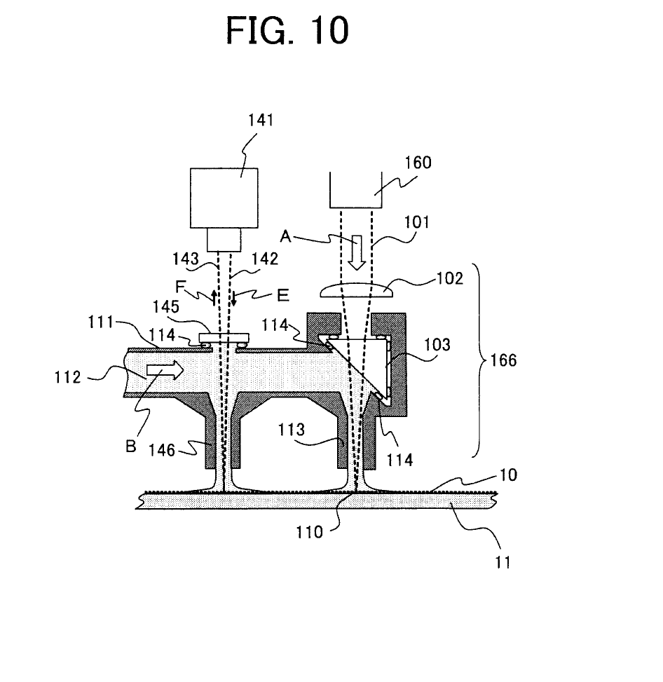

FIG. 10 is a schematic diagram illustrating a configuration of a working head 166 at a time of laser beam illumination in a laser machining apparatus 206 according to Embodiment 6 of the present invention. Embodiment 6 further includes the distance sensor 141 in addition to the working head 161, and a distance measuring entrance window 145 and a distance measuring nozzle 146 in addition to the piping 111, according to Embodiment 1, shown in FIG. 3.

The configuration for other elements and their operations are similar to those in Embodiment 1, and the corresponding elements are labeled with the same reference numerals as in FIG. 3 and their description will not be provided.

Referring to FIG. 10, the distance sensor beam 142 is emitted from the distance sensor 141 in a direction E, passes through the distance measuring entrance window 145, is guided into the cleaning fluid 112, propagates through the a jet of the cleaning fluid 112 discharged from the distance measuring nozzle 146, and then is directed onto the thin film 10 formed on the insulative substrate 11.

The distance sensor beam 142, acting as the control beam, is reflected back by the thin film 10. The distance sensor beam 143, which is the reflected laser beam, returns into the cleaning fluid 112 while propagating through the jet of the cleaning fluid 112 discharged from the distance measuring nozzle 146, and is caused to return, through the distance measuring entrance window 145, to the distance sensor 141 in a direction F. The distance sensor 141 senses the distance between itself and the thin film 10, which serves as the control information, from the returned distance sensor beam 143.

In Embodiment 6, the working head 161 is provided with the distance sensor 141, and the measuring laser beam from the distance sensor 141 is made to pass through the distance measuring entrance window 145 provided on the piping 111 and propagate through the jet of the clean liquid 112 discharged from the distance measuring nozzle 146. Thus, the variation in distance from the working head at the laser-beam illuminated position can be measured accurately.

The distance information thus obtained can be used to adjust the focus point of the laser beam 101.

### Embodiment 7

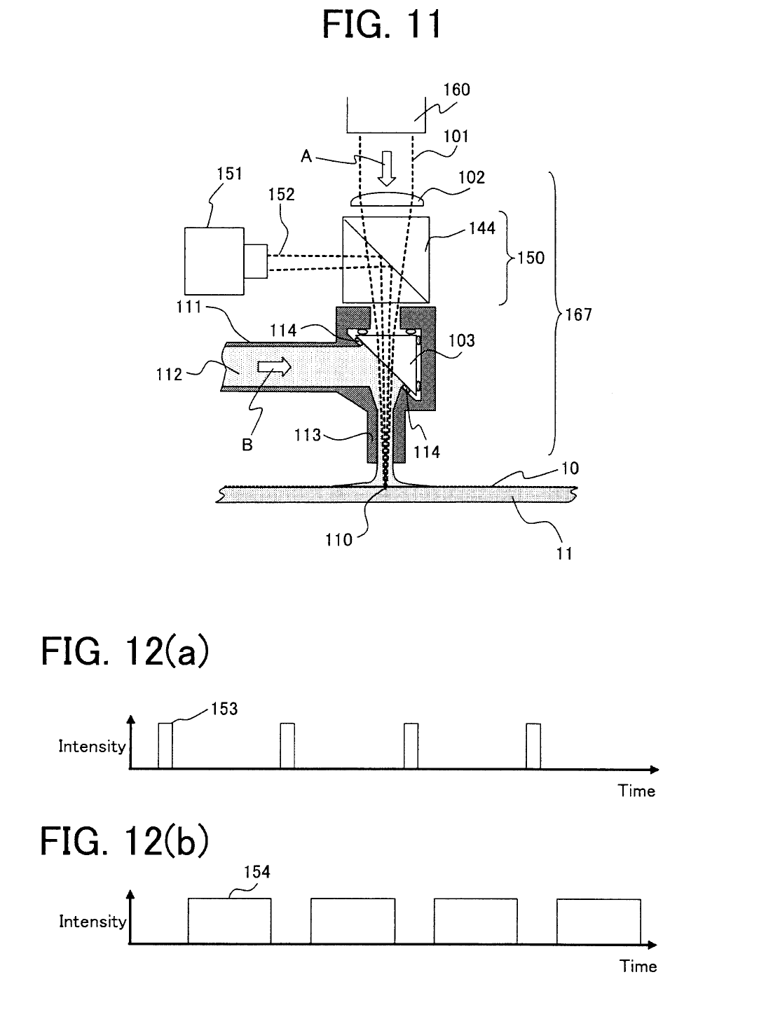

FIG. 11 is a schematic diagram illustrating a configuration of a working head 167 at a time of laser beam illumination in a laser machining apparatus 207 according to Embodiment 7 of the present invention. Embodiment 7 further includes an observation camera unit 150 in addition to the working head 161 according to Embodiment 1, shown in FIG. 3.

The configurations of other elements and their operations are similar to those in Embodiment 1, and the corresponding elements are labeled with the same reference numerals as in FIG. 3 and their description will not be provided.

As shown in FIG. 11, the observation camera unit 150 is constituted with an observation camera 151 and the beam splitter 144.

Referring to FIG. 11, the observation camera 151 is a one-dimensional or two-dimensional camera, such as a CCD camera. The observation beam 152 acting as the control beam is reflected by the beam splitter 144, passes through the beam pencil of the laser beam 101, propagates through the jet of the cleaning fluid 112 discharged from the nozzle 113, and then the working point 110 is observed under magnification. The laser-beam illuminated position serving as the control information can be ascertained using the observation camera 151.

In Embodiment 7, since the working head 161 is provided with the observation camera unit 150, to cause the measuring laser beam 152 of the observation camera 151 to pass through the same optical system as that of the machining laser beam 101, the position of the laser beam illumination can be observed accurately.

The imaging information thus acquired can be used to ascertain the position of scribe portions in the previous steps in scribing processes from the second layer and thereafter. Thus, scanning accuracy of the laser beam can be improved.

Note that by varying a wavelength between the laser beam 101 and the observation beam 152, the distance can be uniformly measured using the wavelength filter.

FIG. 12 is a set of views illustrating observation timing. Referring to FIG. 12, the horizontal axis represents time and the vertical axis, strength. FIG. 12(a) shows timing for a laser pulse 153, and FIG. 12(b), timing for an observation beam 154 from the observation camera.

Noise can be reduced by shifting the timing for the observation beam 154 with respect to the timing for the laser pulse 153, to perform temporal filtering, as shown in FIG. 12.

An example is described where the observation camera 151 is used as a device such as a CCD; however, a sensor that detects positional information of a bright spot of a device such as a PSD may be used for a light-receiving device of the observation camera.

### Embodiment 8

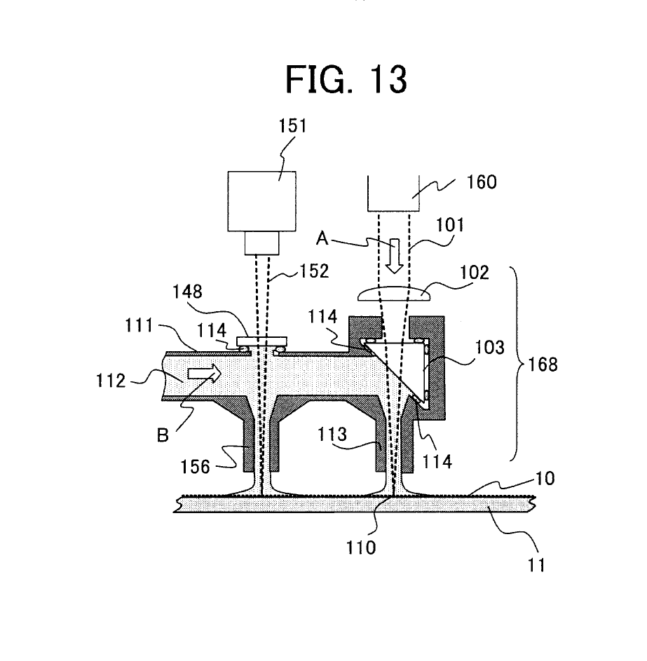

FIG. 13 is a schematic diagram illustrating a configuration of a working head 168 of a laser machining apparatus 208 according to Embodiment 8 of the present invention. Embodiment 8 further includes an observation camera 151 in addition to the working head 161, and an observation entrance window 148 and an observation nozzle 156 in addition to the piping 111, according to Embodiment 1, shown in FIG. 3.

The configurations of other elements and their operations are similar to those in Embodiment 1, and the corresponding elements are labeled with the same reference numerals as in FIG. 3 and their description will not be provided.

Referring to FIG. 13, the observation beam 152 acting as the control beam of the observation camera 151 passes through the observation entrance window 148, is introduced into the cleaning fluid 112, propagates through the jet of the cleaning fluid 112 discharged from the nozzle 156, and the thin film 10 formed on the insulative substrate 11 is observed under magnification. The laser-beam illuminated position serving as the control information can be ascertained using the observation camera 151.

As shown in FIG. 13, since the optical axis of the observation beam 152 is spaced away from the working point 110, the observation camera 151 cannot observe positions of the scribe portions at the previous steps, in the vicinity of the working point 110. However, by observing a front position in the scanning direction of the working head, or a position of the scribed portion of a neighboring region, e.g., the photoelectric conversion region 15, the working point 110 can be measured indirectly but accurately, thus improving the scanning accuracy of the laser beam 101.

In Embodiment 8, the working head 161 is provided with an observation camera 151, and the observation beam 152 from the observation camera 151 is made to pass through the observation entrance window 148 provided on the piping 111 and propagate through the jet of the clean liquid 112 discharged from the observation nozzle 156. Thus, the accurate position can be measured without the influence of the cleaning fluid.

In addition, since the beam region is separated between the observation beam 152 and the laser beam 101, low-noise observations can be achieved.

The imaging information thus acquired can be used to grasp the position of scribed portion in the previous steps in scribing processes from the second layer and thereafter. Thus, scanning accuracy of the laser beam 101 can be improved.

Note that, as with Embodiment 7, by using a different wavelength between the laser beam 101 and the observation beam 152, the distance can be uniformly measured using the wavelength filter.

Noise can be reduced by shifting, as with Embodiment 7, the timing for the observation beam 154 with respect to the timing for the laser pulse 153, to perform temporal filtering.

An example is described where the observation camera 151 is used as a device such as a CCD; however, a sensor that detects positional information of a bright spot of a device such as a PSD may be used for a light-receiving device of the observation camera.

### REFERENCE NUMERALS

Thin film

11 Insulative substrate

101 Laser beam

102 Lens

103 Prism

104 Lens integral with a prism

111 Piping

112 Cleaning fluid

113 Nozzle

120 Beam profile measuring device

131 Power meter

140 Distance sensor unit

141 Distance sensor

142 and 143 Distance sensor beam

145 Distance-measuring entrance window

146 Distance-measuring nozzle

147 Entrance window

148 Observation entrance window

151 Observation camera

152 Observation beam

156 Observation nozzle

160 Laser beam source

161, 162, 163, 164, 165, 166, 167 and 168 Working head

170 Fluid flow controller

201, 202, 203, 204, 205, 206, 207 and 208 Laser beam machining apparatus

1. A laser machining method, comprising:
concurrently with illumination of a workpiece by a laser beam, discharging a columnar jet of cleaning fluid whose diameter is greater than that of the laser beam on substantially the same axis as an optical axis of the laser beam, and
machining the workpiece.

2. The laser machining method of claim 1, wherein when a thin film on a substrate is machined, a beam profile of the laser beam is measured at a location on the side of a substrate surface opposite the laser-beam-illuminated substrate surface, and on the optical axis of the laser beam.

3. The laser machining method of claim 1, wherein when a thin film on a substrate is machined, a beam strength of the laser beam is measured at a location on the side of a substrate surface opposite the laser-beam-illuminated substrate surface, and on the optical axis of the laser beam.

4. The laser machining method of claim 1, wherein a control beam is emitted through an optical path substantially the same as, or substantially parallel to, a partial optical path of the laser beam, and control information is acquired from a reflective beam of the control beam.

5. The laser machining method of claim 4, wherein the control information is distant information.

6. The laser machining method of claim 4, wherein the control information is positional information.

7. A laser machining apparatus, comprising:
a laser beam source that emits a laser beam;
a lens that focuses the laser beam;
a fluid flow controller that supplies cleaning fluid and controls a flow speed of the cleaning fluid;
piping, provided with a window for introducing the focused laser beam thereinto, that flows the cleaning fluid therethrough; and
a nozzle disposed opposite the window for the piping and about substantially the optical axis of the laser beam introduced from the window into the cleaning fluid, and sized so that the laser beam does not make a contact with an inner wall of the nozzle, the nozzle discharging a jet of the cleaning fluid concurrently with illumination of a workpiece by the laser beam propagating in the cleaning fluid.

8. The laser machining apparatus of claim 7, wherein the window is configured with a prism.

9. The laser machining apparatus of claim 7, wherein the window is integral with a lens.

10. The laser machining apparatus of claim 7, further comprising a beam profile measuring unit for measuring, when a thin film on a substrate is machined, a beam profile of the laser beam at a location on the side of a substrate surface opposite the laser-beam-illuminated substrate surface, and on the optical axis of the laser beam.

11. The laser machining apparatus of claim 7, further comprising a power meter that measures, when a thin film on a substrate is machined, a beam strength of the laser beam at a location on the side of a substrate surface opposite the laser-beam-illuminated substrate surface, and on the optical axis of the laser beam.

12. The laser machining apparatus of claim 7, further comprising a control sensor that emits a control beam through an optical path substantially the same as a partial optical path of the laser beam and acquires control information from a reflective beam by a control-beam-illuminated surface.

13. The laser machining apparatus of claim 7, further comprising
a control sensor that acquires control information by means of a beam reflected by a control-beam illuminated surface;
a control window, provided on the piping at a position substantially parallel to a partial optical path of the laser beam, for introducing the control beam therethrough; and
a control nozzle, provided at a position corresponding to the window for the piping, for directing the control beam introduced through the window.

14. The laser machining apparatus of claim 12, wherein the control information is distant information.

15. The laser machining apparatus of claim 12, wherein the control information is positional information.

16. The laser machining method of claim 12, wherein the control information is distant information.

17. The laser machining method of claim 12, wherein the control information is positional information.
